(19) United States
(12) Patent Application Publication
(10) Pub. No.: US 2025/0262978 A1
(43) Pub. Date: Aug. 21, 2025

(54) Traction Battery Controller Employing Representative-Difference Battery Model

(71) Applicant: Ford Global Technologies, LLC, Dearborn, MI (US)

(72) Inventors: Yonghua Li, Ann Arbor, MI (US); Justin T. Hughes, Allen Park, MI (US)

(73) Assignee: Ford Global Technologies, LLC, Dearborn, MI (US)

(21) Appl. No.: 18/443,950

(22) Filed: Feb. 16, 2024

(51) Int. Cl. B60L 58/12; B60L 50/60; H01M 10/44; H01M 10/46; H02J 7/00

(52) U.S. Cl. CPC B60L 58/12; B60L 50/60; H01M 10/441; H01M 10/46; H02J 7/0047; H02J 7/00712; H01M 2220/20

(57) ABSTRACT

A system, such as an electrified vehicle, includes a battery, such as a traction battery. The battery includes cells each having a state. The system further includes a controller that controls the charging and discharging of the battery according to a state of the battery derived at least in part from (i) the state of a first cell and (ii) a difference of the state of a second cell with the state of the first cell.

### TECHNICAL FIELD

The present disclosure relates to detecting operating characteristics of a traction battery of an electrified vehicle for use in controlling the operation of the traction battery and/or the vehicle.

### BACKGROUND

An electrified vehicle includes a traction battery for providing power to a motor of the vehicle to propel the vehicle. Operating characteristics of the traction battery, such as its state-of-charge and its power capability, may be monitored for use in controlling the operation of the traction battery and/or the vehicle.

### SUMMARY

A system includes a battery and a controller. The battery, such as a traction battery of an electrified vehicle, includes cells each having a state. The controller is configured to charge and discharge the battery according to a state of the battery derived at least in part from (i) the state of a first cell and (ii) a difference of the state of a second cell with the state of the first cell.

The controller may be further configured to charge and discharge the battery according to the state of the battery derived from the state of the first cell and the state of the second cell, with the state of the second cell being a summation of the (i) the state of the first cell and (ii) the difference of the state of the second cell with the state of the first cell.

The controller may be further configured to charge and discharge the battery according to the state of the battery derived at least in part from (i) the state of the first cell, (ii) the difference of the state of the second cell with the state of the first cell, and (iii) a difference of the state of a third cell with the state of the first cell.

The controller may be further configured to charge and discharge the battery according to the state of the battery derived at least in part from factor A and factor B, where the factor A is (i) the state of the first cell and (ii) the difference of the state of the second cell with the state of the first cell, and the factor B is (i) the state of a third cell and (ii) a difference of the state of a fourth cell with the state of the third cell.

The controller may be further configured to detect the state of the first cell via a first Kalman filter computing structure and to detect the difference of the state of the second cell with the state of the first cell via a second Kalman filter computing structure that is simpler than the first Kalman filter computing structure.

The controller may be further configured to detect the state of the first cell periodically at a first rate and to detect the difference of the state of the second cell with the state of the first cell periodically at a second rate that is equal to or slower than the first rate.

The controller may be further configured to select one of the cells of the battery as being the first cell based on predetermined criteria whereby the first cell is representative of the cells of the battery according to the predetermined criteria.

The state of each cell of the battery may be a state-of-charge (SOC). In this case, the controller may be further configured to charge and discharge the battery according to a SOC of the battery derived at least in part from (i) the SOC of the first cell and (ii) the difference of the SOC of the second cell with the SOC of the first cell.

The state of each cell of the battery may be a charge capacity and a power capability. In this case, the controller may be further configured to charge and discharge the battery according to a charge capacity of the battery derived at least in part from (i) the charge capacity of the first cell and (ii) the difference of the charge capacity of the second cell with the charge capacity of the first cell and/or according to a power capability of the battery derived at least in part from (i) the power capability of the first cell and (ii) the difference of the power capability of the second cell with the power capability of the first cell.

A method includes detecting a state of a first cell of a battery based on electrical measurements of the first cell. The method further includes detecting a difference of a state of a second cell of the battery with the state of the first cell based on electrical measurements of the second cell and on the state of the first cell and detecting the state of the second cell from a summation of (i) the state of the first cell and (ii) the difference of the state of the second cell with the state of the first cell. The method further includes charging and discharging the battery according to a state of the battery derived from a summation of the state of the first cell and the state of the second cell.

An electrified vehicle includes a traction battery and a controller. The traction battery has modules, each module including cells. The controller is configured to select a cell of each module as being a representative cell that is representative of the cells of the module according to predetermined criteria with the other cells of the module being considered as being difference cells. The controller is further configured to detect a state of the representative cell of each module based on electrical measurements of the representative cell. The controller is further configured to detect a difference of a state of each difference cell of each module with the state of the representative cell of the module based on electrical measurements of the difference cell and on the state of the representative cell. The controller is further configured to detect the state of each difference cell of each module from a summation of (i) the state of the representative cell of the module and (ii) the difference of the state of the difference cell with the state of the representative cell. The controller is further configured to charge and discharge the battery according to a state of the battery derived from a summation for each module of the state of the representative cell of the module and the states of the difference cells of the module.

### BRIEF DESCRIPTION OF THE DRAWINGS

FIG. 1 illustrates a block diagram of a battery electric vehicle (BEV);

FIG. 2 illustrates a block diagram of an arrangement for a traction battery controller of the BEV to monitor a traction battery of the BEV;

FIG. 3 illustrates a schematic diagram of a conventional equivalent circuit model (ECM) of the traction battery;

FIG. 4 illustrates a flowchart describing operation of the traction battery controller in implementing a representative-difference model (“RDM”) process for the traction battery in order to measure operating characteristics of battery cells of the traction battery on an individualized basis and thereby provide battery cell level control of the traction battery; and

FIG. 5 illustrates a high-level diagram for the RDM process.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

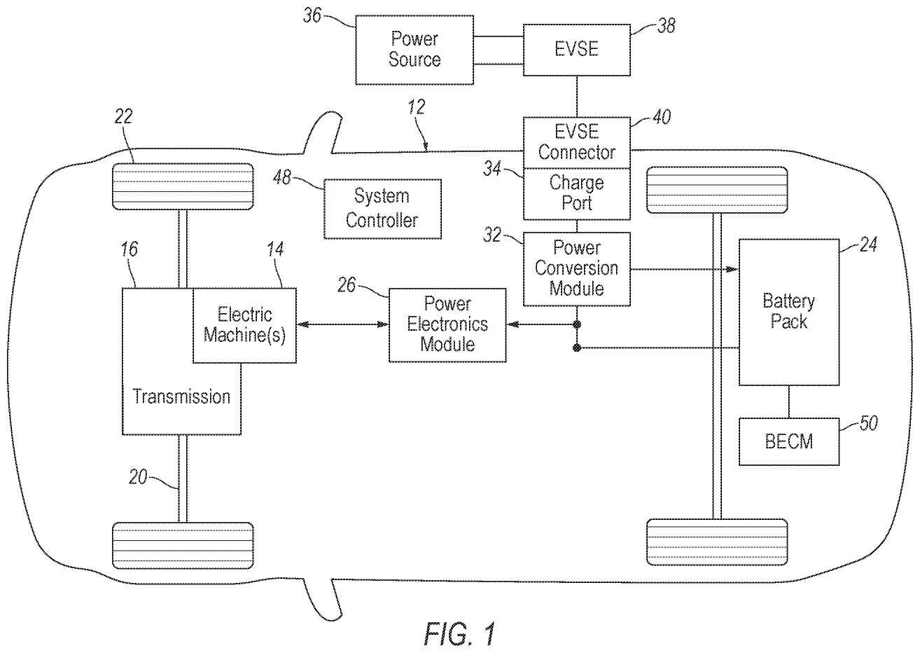

Referring now to FIG. 1, a block diagram of an electrified vehicle (EV) 12 in the form of a battery electric vehicle (BEV) is shown. BEV 12 includes a powertrain having one or more traction motors (“electric machine(s)”) 14, a traction battery (“battery” or “battery pack”) 24, and a power electronics module 26 (e.g., an inverter). In the BEV configuration, traction battery 24 provides all of the propulsion power and the vehicle does not have an engine. In other variations, the EV may be a plug-in (or regular) hybrid electric vehicle (HEV) further having an engine.

Traction motor 14 is part of the powertrain of BEV 12 for powering movement of the BEV. In this regard, traction motor 14 is mechanically connected to a transmission 16 of BEV 12. Transmission 16 is mechanically connected to a drive shaft 20 that is mechanically connected to wheels 22 of BEV 12. Traction motor 14 can provide propulsion capability to BEV 12 and is capable of operating as a generator. Traction motor 14 acting as a generator can recover energy that may normally be lost as heat in a friction braking system of BEV 12.

Traction battery 24 stores electrical energy that can be used by traction motor 14 for propelling BEV 12. Traction battery 24 typically provides a high-voltage (HV) direct current (DC) output. Traction battery 24 is electrically connected to power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In addition to providing electrical energy for propulsion of BEV 12, traction battery 24 may provide electrical energy for use by other electrical systems of the BEV including HV loads such as electric heater and air-conditioner systems, and low-voltage (LV) loads such as an auxiliary battery.

Traction battery 24 is rechargeable by an external power source 36 (e.g., the grid). External power source 36 may be electrically connected to electric vehicle supply equipment (EVSE) 38. EVSE 38 provides circuitry and controls to control and manage the transfer of electrical energy between external power source 36 and BEV 12. External power source 36 may provide DC or AC electric power to EVSE 38. EVSE 38 may have a charge connector 40 for plugging into a charge port 34 of BEV 12. A power conversion module 32 of EV 12, such as an on-board charger having a DC/DC converter, may condition power supplied from EVSE 38 to provide the proper voltage and current levels to traction battery 24. Power conversion module 32 may interface with EVSE 38 to coordinate the delivery of power to traction battery 24.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. Controller 48 may be a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50. BECM 50 is in communication with traction battery 24. BECM 50 is a traction battery controller operable for managing the charging and discharging of traction battery 24 and for monitoring operating characteristics of the traction battery. BECM 50 is operable to implement algorithms to detect (e.g., estimate) the operating characteristics of traction battery 24. BECM 50 controls the operation and performance of traction battery 24 based on the operating characteristics of the traction battery. The operation and performance of other systems and components of BEV 12 may be controlled by BECM 50 and/or other controllers of the BEV based on the operating characteristics of traction battery 24.

Operating characteristics of traction battery 24 include its charge capacity and its state-of-charge (SOC). The charge capacity of traction battery 24 is indicative of the maximum amount of electrical energy that the traction battery may store. The SOC of traction battery 24 is indicative of a present amount of electrical charge stored in the traction battery. The SOC of traction battery 24 may be indicated as a percentage of the maximum amount of electrical charge that may be stored in the traction battery. BECM 50 may output the SOC of traction battery 24 to inform the driver of BEV 12 how much charge remains in the traction battery, similar to a fuel gauge.

Another operating characteristic of traction battery 24 is its power capability. The power capability of traction battery 24 is a measure of the maximum amount of power the traction battery can provide (i.e., discharge) or receive (i.e., charge) for a specified time period. As such, the power capability of traction battery 24 corresponds to discharge and charge power limits which define the amount of electrical power that may be supplied from or received by the traction battery at a given time. These limits can be provided to other vehicle controls, for example, through a vehicle system controller (VSC), so that the information can be used by vehicle systems that may draw power from or provide power to traction battery 24. Vehicle controls are to know how much power traction battery 24 can provide (discharge) or take in (charge) in order to meet the driver demand and to optimize the energy usage. As such, knowing the power capability of traction battery 24 allows electrical loads and sources to be managed such that the power requested is within the limits that the traction battery can handle.

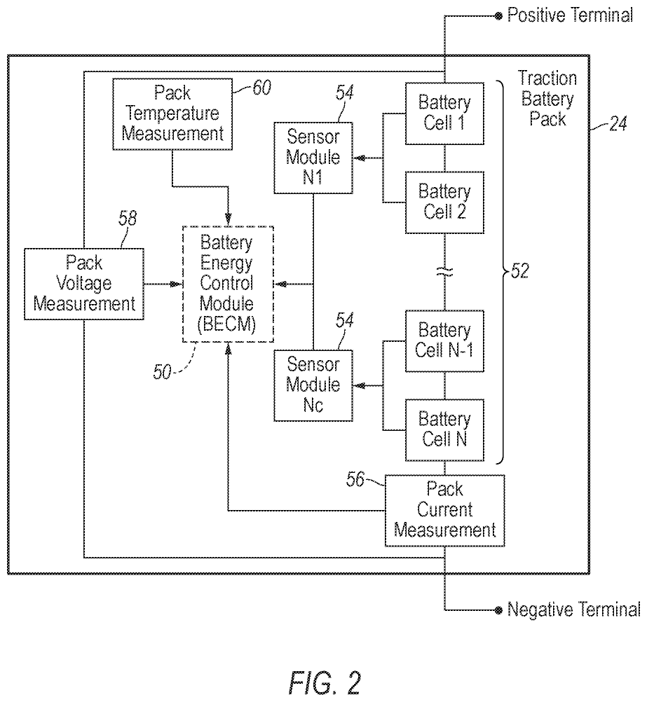

Referring now to FIG. 2, with continual reference to FIG. 1, a block diagram of an arrangement for BECM 50 to monitor traction battery 24 is shown. As indicated in FIG. 2, traction battery 24 is comprised of a plurality of battery cells 52. Battery cells 52 are physically connected together (e.g., connected in series as shown in FIG. 2). More generally, traction battery 24 comprises one or more battery cell modules that are electrically connected together, and each battery cell module comprises one or more battery cells 52 that are electrically connected together. For simplicity of discussion, it is assumed that the battery cell module(s) are connected in series and that battery cells 52 are connected in series.

BECM 50 is operable to monitor pack level (i.e., traction battery level) characteristics of traction battery 24 such as battery current 56, battery voltage 58, and battery temperature 60. Battery current 56 is the current outputted (i.e., discharged) from or inputted (i.e., charged) to traction battery 24. Battery voltage 58 is the terminal voltage of traction battery 24.

BECM 50 is also operable to measure and monitor battery cell level characteristics of battery cells 52 of traction battery 24. For example, terminal voltage, current, and temperature of one or more of battery cells 52 may be measured. BECM 50 may use a battery sensor 54 to measure the battery cell level characteristics. Battery sensor 54 may measure the characteristics of one or multiple battery cells 52. BECM 50 may utilize Nc battery sensors 54 to measure the characteristics of all battery cells 52. Each battery sensor 54 may transfer the measurements to

BECM 50 for further processing and coordination. Battery sensor 54 functionality may be incorporated internally to BECM 50.

Traction battery 24 may have one or more temperature sensors such as thermistors in communication with BECM 50 to provide data indicative of the temperature of battery cells 52 of the traction battery for the BECM to monitor the temperature of the traction battery and/or the battery cells. BEV 12 may further include a temperature sensor to provide data indicative of ambient temperature for BECM 50 to monitor the ambient temperature.

BECM 50 controls the operation and performance of traction battery 24 based on the monitored traction battery and battery cell level characteristics. For instance, BECM 50 may use the monitored characteristics to detect operating characteristics of traction battery 24 (e.g., the SOC of the traction battery, the power capability of the traction battery, and the like) such as for use in controlling the traction battery and/or BEV 12.

As known by those of ordinary skill in the art, BECM 50 may measure operating characteristics of traction battery 24 by using an observer, wherein a battery model (i.e., an “Equivalent Circuit Model” (ECM)) is used for construction of the observer, with measurements of battery current, battery terminal voltage, and battery temperature. BECM 50 may estimate values of parameters of the ECM (e.g., resistances and capacitances of circuit elements of the ECM) and values of states of the ECM (e.g., voltages and currents across circuit elements of the ECM) through recursive estimation based on such measurements. For instance, BECM 50 may use some adaptive estimation method, such as a Kalman filter or an extended Kalman filter (EKF) (collectively “Kalman filter”), to estimate the values of the model parameters and model states.

As an overview, a Kalman filter is an algorithm for estimating the internal state of traction battery 24 given the ECM and measurements of battery current, battery terminal voltage, and battery temperature. The input to the ECM is the measured battery current and the output of the ECM is the measured battery terminal voltage. The Kalman filter predicts what it expects to see as the battery terminal voltage given its present internal state estimate and the measured battery current, compares its estimate of the battery terminal voltage to the measured battery terminal voltage, and updates the values of the parameters and states of the ECM accordingly, in the direction of reducing the estimation error of the estimated battery terminal voltage.

As set forth, an accurate model of traction battery 24 enables BECM 50 to properly control the traction battery which directly affects vehicle performance and driving range for a given full charge. ECMs are widely used in electrified vehicle traction battery control systems in order to satisfy real time control system requirements for calculation speed and RAM/ROM usage. Particularly, an n-RC ECM where n=1 or 2 is widely used (an n-RC ECM is a type of ECM having “n” RC circuit elements each including a resistor (“R”) parameter and a capacitor (“C”) parameter; with n=1, a 1-RC ECM includes one such RC circuit element; and with n=2, a 2-RC ECM includes two such RC circuit elements). As indicated, the parameters for the ECM are learned by BECM 50 with an online learning method such a Kalman filter.

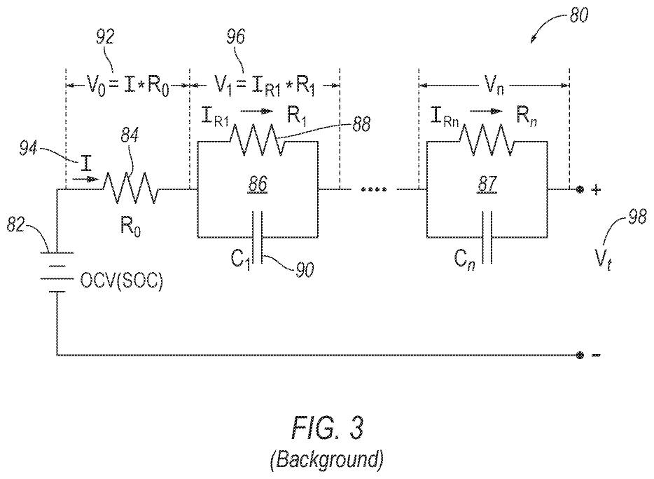

Referring now to FIG. 3, with continual reference to FIG. 1, a schematic diagram of an ECM 80 of traction battery 24 is shown. Per ECM 80, traction battery 24 is modeled as a circuit having in series a voltage source (OCV/(SOC)) 82, a resistor R₀ 84, a first RC pair 86 having a first resistor R₁ 88 and a first capacitor C₁ 90 connected in parallel, and one or more such additional RC pairs 87. As such, ECM 80 is an n-RC ECM where n≥2.

Voltage source 82 represents the open-circuit voltage (OCV) of traction battery 24. The OCV of traction battery 24 depends on the state-of-charge (SOC) of the traction battery and the temperature of the traction battery. The OCV of traction battery 24 is not readily measurable. Given an estimate of the OCV of traction battery 24 and the measured temperature, BECM 50 can measure the SOC of the traction battery.

Resistor Ro 84 represents an internal resistance of traction battery 24. The RC pairs represent the diffusion process of traction battery 24. As such, the diffusion process of traction battery 24 in conventional ECM 80 is described with RC pairs R₁ and C₁, . . . , Rₙ and Cₙ. Voltage V₀ 92 is the voltage drop across resistor R₀ 84 due to battery current I 94 which flows across resistor R₀ 84. Voltage V₁ 96 is the voltage drop across first RC pair 86 due to battery current I_{R1} which flows across resistor R₁ 88. A voltage drop is across each additional RC pair 87. Voltage Vₜ 98 is the voltage across the terminals of traction battery 24 (i.e., the terminal voltage). The terminal voltage of traction battery 24 is measurable.

Parameters of ECM 80 include the resistors (i.e., resistor R₀, resistor R₁, and resistor Rₙ) and the capacitors (i.e., capacitor C₁ and capacitor Cₙ). The parameters are to have values whereby the calculated output of ECM 80 in response to a hypothetical given input is representative of the actual output of traction battery 24 in response to the actual given input. As such, the values of the parameters of ECM 80 have to be accurate so that the ECM accurately models the behavior of traction battery 24.

As indicated, the values of the parameters can be learned online by BECM 50 such as with a Kalman filter. Understandably, it is much easier for BECM 50 to learn the values of a few parameters as opposed to learning the values of many parameters. Consequently, as a practical matter, ECM 80 is typically only a ₁-RC ECM or a ₂-RC ECM.

As set forth, the approach of applying an ECM and a Kalman filter to traction battery 24 enables the measurement of operating characteristics of the traction battery. Further, traction battery 24 has electrical characteristics that are directly related to the electrical characteristics of battery cells 52. For instance, in a series-connected traction battery, the voltage of the traction battery is the sum of the individual battery cell voltages, and the current of the traction battery is equal to the individual battery cell currents. Therefore, as known by those of ordinary skill in the art, a battery model such as ECM 80 may be used for construction of an observer to measure operating characteristics of a battery cell 52. That is, a first ECM 80 may be considered as being a model for modeling a first battery cell 52, a second ECM 80 may be considered as being a model for modeling a second battery cell 52, etc.

With ECM 80 being considered as a model for modeling a battery cell 52, BECM 50 may measure operating characteristics of the battery cell by using an observer constructed from the ECM, with measurements of battery cell current, battery cell terminal voltage, and battery cell temperature. BECM 50 may estimate values of parameters and states of the ECM through recursive estimation based on such battery cell measurements with the use of a Kalman filter.

The approach of applying an ECM and a Kalman filter to a battery cell 52 enables the measurement of operating characteristics of the battery cell. BECM 50 could replicate this approach N times for N battery cells 52 of traction battery 24 to measure operating characteristics of each battery cell on an individual basis. A purpose of measuring operating characteristics of battery cells 52 on an individual basis is for BECM 50 to obtain therefrom a more accurate measurement of the operating characteristics of traction battery 24. In this way, BECM 50 would provide battery cell level control for controlling traction battery 24.

However, the approach of applying an ECM and a Kalman filter for a dynamic system, such as traction battery 24 or any of battery cells 52, to detect a complete internal state of the dynamic system will consume a relatively large amount of computing resources of BECM 50. As such, it is not practical for BECM 50 to replicate this approach N times to detect complete internal states of N battery cells 52 as traction battery 24 typically includes a few dozen or more battery cells (e.g., 96 battery cells).

In sum, a traction battery may be composed of multiple battery modules (arrays), with each battery module containing multiple battery cells (e.g., twelve or more equivalent battery cells) connected in series (each equivalent battery cell may consist of multiple battery cells connected in parallel). In order to control a traction battery with such a configuration on the battery cell level, a model-based solution, e.g., a solution that uses an ECM, is required to run a relatively large number (e.g., hundreds) of Kalman filters. The Kalman filter computing structure to detect a complete internal state of any one battery cell is a relatively complex computing structure requiring a relatively large amount of computing processing and memory resources. As such, a BECM that can deal with battery cell level controls for a traction battery, without using the relatively complex Kalman filter computing structure for each battery cell, is thus desired for more accurate control of the traction battery.

In accordance with the present disclosure, BECM 50 employs a “representative-difference” model (“RDM”) process for traction battery 24 in order to measure operating characteristics of battery cells 52 of traction battery 24 on an individualized basis and thereby provide battery cell level control of the traction battery. The RDM process involves BECM 50 implementing a first algorithm to detect a complete internal state of a battery cell 52 of traction battery 24 (“the representative cell”) and implementing a second algorithm to detect differences between other battery cells of the traction battery (“the difference cells”) with the representative cell. BECM 50 then detects the complete internal state of each difference cell based on the differences of the difference cell with the representative cell. BECM 50 then uses the complete internal states of the representative and difference cells to obtain therefrom operating characteristics of traction battery 24.

For instance, BECM 50 implements the first algorithm to detect the SOC of the representative cell and implements the second algorithm to detect the difference in the SOC of a first difference cell with the SOC of the representative cell, the difference in the SOC of a second difference cell with the SOC of the representative cell, etc. BECM 50 then detects the SOC of the first difference cell by summing the SOC difference of the first difference cell and the SOC of the representative cell, the SOC of the second difference cell by summing the SOC difference of the second difference cell and the SOC of the representative cell, etc. BECM 50 uses the SOCs of the representative and difference cells to obtain therefrom the SOC of traction battery 24.

The first algorithm to detect a complete internal state of the representative cell, such as for detecting the SOC of the representative cell, employs the relatively complex Kalman filter computing structure (herein, “the full EKF”) in the manner described above. The second algorithm to detect the differences between the difference cells and the representative cell, such as for detecting the SOC differences of the difference cells with the representative cell, employs an iteration of a relatively simple Kalman filter computing structure (herein, “the difference EKF”) for each difference cell. For instance, when there are nine difference cells, the second algorithm employs nine iterations of the difference EKF. The difference EKF for each difference cell is relatively simple as differences between the difference cell and the representative cell are detected by the difference EKF, as opposed to the complete internal state of the difference cell being directly detected as is done for the representative cell.

As an iteration of the difference EKF is employed for each difference cell, N-1 iterations of the difference EKF are employed for N-1 difference cells. In this case, N Kalman filter computing structures are employed (one full EKF for the representative cell and N-1 difference EKFs for the N-1 difference cells). However, the difference EKF is much simpler than the full EKF. As a result, the computing processing and memory resources expended for implementing all of the difference EKFs is relatively much less than the resources expended for implementing a like amount of the full EKFs.

Further, as changes in the differences between the difference cells and the representative are relatively much slower than changes in the internal state of the representative cell, the differences between the difference cells and the representative cell do not need to be detected as often as the internal state of the representative cell is detected. For instance, as changes in the SOC differences of the difference cells with the SOC of the representative cell are relatively much slower than changes in the SOC of the representative cell, the difference EKFs can be implemented less frequently than the full EKF.

Depending on the resources of BECM 50, one or more additional battery cells 52 of traction battery 24 may be designated as a representative cell(s). In this case, the difference cells are divided into subsets for comparison with corresponding ones of the representative cells. For instance, traction battery 24 may have ten battery cells (i.e., N=10) with two of the battery cells being designated as representative cells and the eight remaining battery cells being designated as difference cells. A first set of five difference cells may correspond to the first representative cell and a second set of three other difference cells may correspond to the second representative cell. In this case, the first algorithm employs a first iteration of the full EKF to detect the complete internal state of the first representative cell and a second iteration of the full EKF to detect the complete internal state of the second representative cell. The second algorithm employs five iterations of the difference EKF to detect the differences of the first set of five difference cells with the first representative cell and three more iterations of the difference EKF to detect the differences of the second set of three difference cells with the second representative cell.

The representative cell may be “representative” of the battery cells of traction battery 24 depending on some criteria, for instance, voltage, temperature, location, and/or capacity of the representative cell is closest to an average of the voltage, temperature, location, and/or capacity of all of the battery cells in a group (e.g., a particular module or the entire battery).

In sum, in accordance with the present disclosure, BECM 50 implements an overall relatively efficient computational structure for measuring the operating characteristics of battery cells 52 in providing battery cell level control. The computational structure implemented by BECM 50 involves (i) the BECM identifying a battery cell(s) amongst battery cells 52 as being a representative of the battery cells (i.e., “the representative cell”) and (ii-a) the BECM applying a complex filter (i.e., the full EKF) to the representative cell to measure operating characteristics of the representative cell and (ii-b) the BECM, for each remaining battery cell (i.e., each “difference cell”), the BECM applying a simple filter (i.e., the difference EKF) to the difference cell to measure differences between the difference cell and the representative cell in order to measure operating characteristics of the difference cell. BECM 50 uses the measured operating characteristics of the representative and difference cells to obtain therefrom the operating characteristics of traction battery 24.

As such, BECM 50 implements the RDM process for traction battery 24 in providing battery cell level control for controlling the traction battery and/or BEV 12. The RDM process involves the designation of a “representative” or multiple “representatives” among battery cells within each module of the traction battery. The battery cells other than the representative cell(s) are considered as being “difference” cells. BECM 50 implements the RDM process by fully estimating the representative cell and by estimating each difference cell based on differences (e.g., voltage differences) between the difference cell and the representative cell.

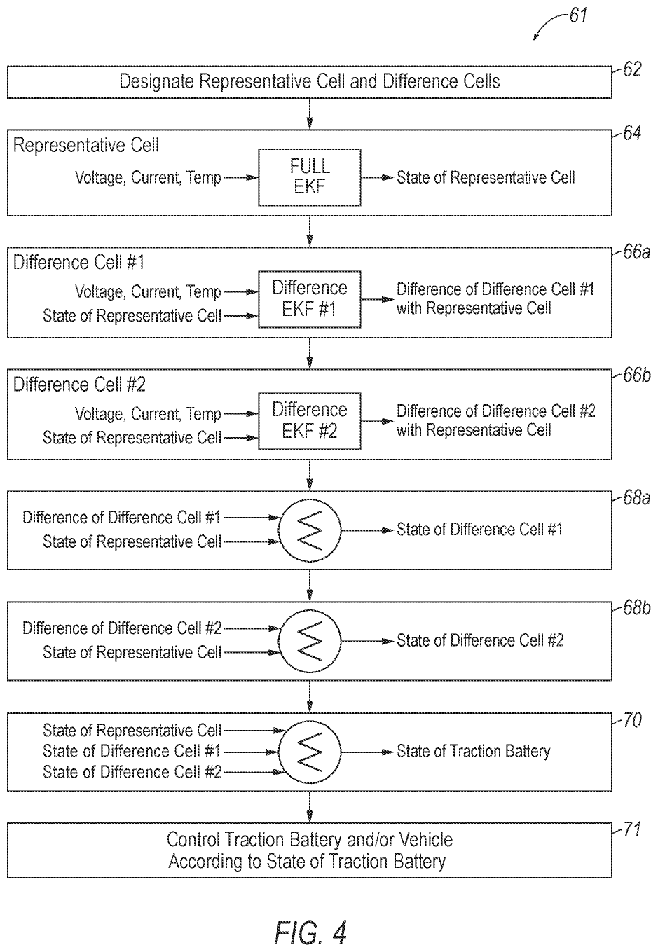

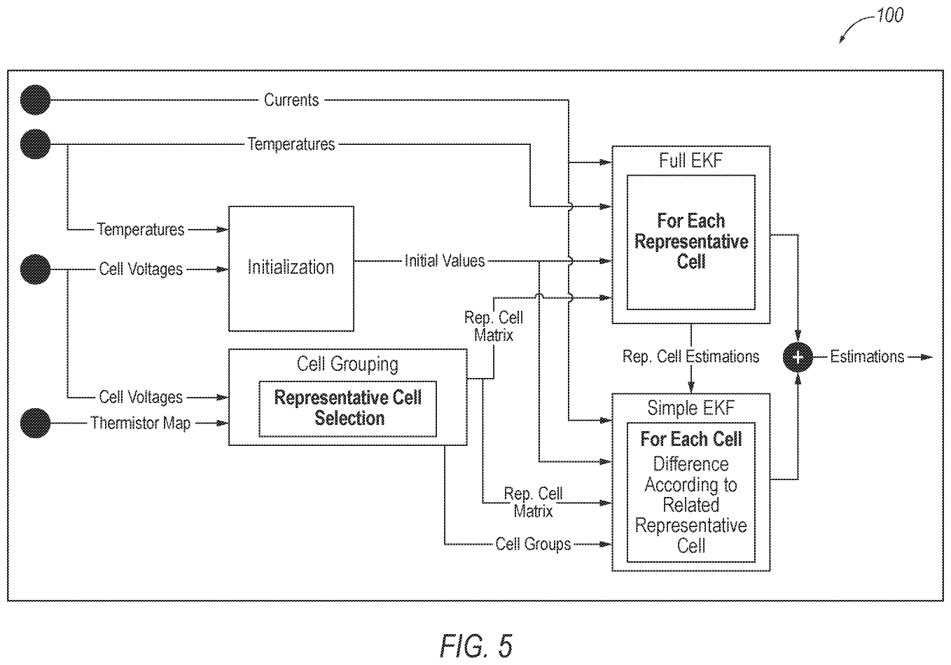

Referring now to FIG. 4, with continual reference to FIG. 5, a flowchart 61 describing operation of BECM 50 in implementing the RDM process for traction battery 24 in order to measure operating characteristics of battery cells 52 on an individualized basis and thereby provide battery cell level control of traction battery 24 is shown. FIG. 5 illustrates a high-level diagram 100 for the RDM process. As shown in FIG. 4, the operation begins with BECM 50 designating one or more of battery cells 52 of traction battery 24 as being representative cells, as indicated by block 62. The remaining battery cells 52 of traction battery 24, i.e., those battery cells not designated as being representative cells, are designated as being difference cells, as further indicated in block 62.

As such, a pack of N_{T} total (logical) battery cells of traction battery 24 is regarded as having N_{R} representative cells and N_{L} difference cells, where N_{T}=N_{R}+N_{L}. Assuming N_{T} is greater than N_{A} (N_{A} being the number of modules of traction battery 24), BECM 50 may enforce at least one representative cell per module with the difference cells being associated with the representative cell from the same module. If not, then age, chemistry, etc., could be added as a clustering dimension. Further, BECM 50 may consider voltage, temperature, and/or capacity of battery cells 52 when considering which battery cells to designate as representative cells. Each representative cell has some set of difference cells associated therewith. Occasionally, such set of difference cells may be empty, i.e., a representative cell is not associated with any difference cells. BECM 50 may make use of a clustering algorithm, such as disclosed in U.S. Pat. No. 8,972,091, to discern which battery cells 52 to designate as representative cells. The clustering algorithm may be computationally expensive and therefore may only be performed infrequently, e.g., at key-on, or even less frequently. Prior clustering can also be used as an initial condition.

Further, representative cells and their associated difference cells can be designated as such by using a clustering method, e.g., k-means. The number of representative cells per module can differ. More representative cells can be given to modules with heterogeneity. Again, possible constraints on the clustering can be at least X representative cells per module; exactly X representative cells per module; associations must be within the same module; or the like. Outlier battery cells will often be the limiting battery cells in terms of SOC and power capability. Outlier detection (or simply using a clustering method that is not robust to outliers) can be used to ensure these battery cells are selected as representative cells. This may only be desirable when multiple representative cells are allowed per module. Lastly, every powerup cycle may introduce different representative cells, although the total numbers may be fixed.

As an overview, each battery cell 52 has a complete internal state estimate. For the representative cell, BECM 50 employs the full EKF to directly detect the complete internal state of the representative cell. For each difference cell, BECM 50 employs the simple EKF to detect one or more differences of the difference cell with the representative cell. BECM 50 then detects the complete internal state of the difference cell based on (i) the differences of the difference cell with the representative cell and (ii) the complete internal state of the representative cell. Through the saved states and representative difference mappings, the entire state of traction battery 24 can be saved and reinitialized with different representative cells. Alternatively, BECM 50 detects at least part of the internal state of the difference cell based on the differences of the difference cell with the representative cell (e.g., SOC, R₀). Any remaining part of the internal state of the difference cell may be shared with the representative cell (e.g., V₁, V₂).

For simplicity, in this example, only one battery cell 52 is designated as being a representative cell with the remaining battery cells being designated as difference cells. After battery cells 52 have been designated as being the representative cell or the difference cells, the operation continues with BECM 50 applying the full EKF to the representative cell to detect a complete internal state of the representative cell, as indicated by block 64. As described herein, applying the full EKF to the representative cell involves using an ECM 80 of the representative cell and a Kalman filter along with terminal voltage, current, and/or temperature measurements of the representative cell to detect a complete internal state of the representative cell. The complete internal state of the representative cell provides operating characteristics of the representative cell including the SOC, the charge capacity, and the power capability of the representative cell.

The operation continues with BECM 50 applying an iteration of the simple EKF to each difference cell to detect a difference of the difference cell with the representative cell. Particularly, BECM 50 applies a first iteration of the simple EKF to a first difference cell as indicated in block 66a and BECM 50 applies a second iteration of the simple EKF to a second difference cell as indicated in block 66b. BECM 50 applies further iterations of the simple EKF to remaining difference cells. For simplicity, the illustrated operation steps of method 61 provide for only two iterations of the simple EKF for the first and second difference cells.

Applying the simple EKF to a difference cell involves using a Kalman filter along with terminal voltage, current, and/or temperature measurements of the difference cell in conjunction with the detected internal state of the representative cell to detect differences of the difference cell with the representative cell. The simple EKF involves utilizing simplistic state and output equations for the difference cell.

For example, BECM 50 applies the simple EKF to a difference cell to detect the SOC difference of a difference cell with the SOC of the representative cell. Therefore, a state equation and an output equation are utilized for the SOC difference in order to design a Kalman filter to detect the SOC difference. A suitable state equation is Δz=z_{diff}−zᵣₑₚ, where Δz is the SOC difference of the difference cell with the SOC of the representative cell, z_{diff} is the (unknown) SOC of the difference cell, and zᵣₑₚ is the SOC of the representative cell (zᵣₑₚ is known as it is a component of the detected internal state of the representative cell). An output equation suitable for combining with this state equation is y=OCV(zᵣₑₚ+Δz), where y is the terminal voltage of the difference cell, OCV is the open circuit voltage of the difference cell, and the sum of zᵣₑₚ+Δz is the SOC of the difference cell. To detect Δz (i.e., the SOC difference of the difference cell with the SOC of the representative cell), a Kalman filter is used with these two equations. As it is a single-state Kalman filter (i.e., the simple EKF), it is relatively much faster than a multi-state Kalman filter (i.e., the full EKF). In like fashion, other state equations and output equations can be utilized for detecting a charge capacity difference or a power capability of the difference cell with the charge capacity or the power capability of the representative cell.

After BECM 50 detects the differences of the difference cells with the representative cell, the operation continues with BECM 50 detecting the internal state of each difference cell. BECM 50 detects the internal state of a difference cell based on the difference of the difference cell and on the detected internal state of the representative cell. Particularly, BECM 50 detects the internal state of the first difference cell based on the difference of the first difference cell and the detected internal state of the representative cell, as indicated in block 68a. Likewise, BECM 50 detects the internal state of the second difference cell based on the difference of the second difference cell and the detected internal state of the representative cell, as indicated in block 68b. In this way, the internal states of battery cells 52 are obtained on an individualized battery cell basis.

For example, BECM 50 detects the SOC of the first difference cell as a summation of (i) the SOC difference of the first difference cell with the SOC of the representative cell and (ii) the SOC of the representative cell, i.e., z_{diff_#1}=Δz_{#1}+zᵣₑₚ, where z_{diff_#1} is the SOC of the first difference cell, Δz_{#1} is the SOC difference of the first difference cell with the SOC of the representative cell, and zᵣₑₚ is the SOC of the representative cell. Likewise, BECM 50 detects the SOC of the second difference cell as a summation of (i) the SOC difference of the second difference cell with the SOC of the representative cell and (ii) the SOC of the representative cell, i.e., z_{diff_#2}=Δz_{#2}+zᵣₑₚ, where z_{diff_#2} is the SOC of the second difference cell, Δz_{#2} is the SOC difference of the second difference cell with the SOC of the representative cell, and zᵣₑₚ is the SOC of the representative cell. As such, in this way, the SOCs (zᵣₑₚ, z_{diff_#1}, z_{diff_#2}, . . . , z_{diff_#N-1}) of N battery cells 52 (i.e., operating characteristics of the battery cells) are obtained on an individualized basis. In similar fashion, BECM 50 may detect the charge capacity and the power capability of each difference cell.

After BECM 50 detects the internal state of each difference cell, the operation continues with BECM 50 detecting the state of traction battery 24. BECM 50 detects the state of traction battery 24 based on the detected internal state of the representative cell and on the detected internal states of the difference cells, as indicated by block 70.

For example, BECM 50 detects the SOC of traction battery 24 based on the SOC of the representative cell and the SOC of each difference cell, i.e., z_{batt}=(zᵣₑₚ+z_{diff_#1}+z_{diff_#2}+. . .+z_{diff_#N-1})/N, where z_{batt} is the SOC of the traction battery, zᵣₑₚ is the SOC of the representative cell, z_{diff_#1} is the SOC of the first difference cell, z_{diff_#2} is the SOC of the second difference cell, z_{diff_#N-1} is the SOC of the N-1 difference cell, and N is the total amount of battery cells of traction battery 24, with the assumption that there is only one representative cell.

The operation continues with BECM 50 controlling the operation of traction battery 24 and/or other components of BEV 12 according to the detected state of the traction battery, as indicated by block 71. For instance, BECM 50 controls the operation of traction battery 24 and/or other components of BEV 12 according to the detected SOC of the traction battery. As an example, BECM 50 may control traction battery 24 to increase (decrease) discharging while the SOC of the traction battery is greater (lesser) than a predetermined threshold. In the case of the vehicle being a full HEV or a plug-in HEV, BECM 50 may control components of the vehicle to increase (decrease) charging to traction battery 24 while the SOC of the traction battery is lower (greater) than a predetermined threshold.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A system comprising:
a battery including cells each having a state; and
a controller configured to charge and discharge the battery according to a state of the battery derived at least in part from (i) the state of a first cell and (ii) a difference of the state of a second cell with the state of the first cell.

2. The system of claim 1 wherein:
the controller is further configured to charge and discharge the battery according to the state of the battery derived from the state of the first cell and the state of the second cell, with the state of the second cell being a summation of the (i) the state of the first cell and (ii) the difference of the state of the second cell with the state of the first cell.

3. The system of claim 1 wherein:
the controller is further configured to charge and discharge the battery according to the state of the battery derived at least in part from (i) the state of the first cell, (ii) the difference of the state of the second cell with the state of the first cell, and (iii) a difference of the state of a third cell with the state of the first cell.

4. The system of claim 1 wherein:
the controller is further configured to charge and discharge the battery according to the state of the battery derived at least in part from factor A and factor B, where factor A is (i) the state of the first cell and (ii) the difference of the state of the second cell with the state of the first cell, and factor B is (i) the state of a third cell and (ii) a difference of the state of a fourth cell with the state of the third cell.

5. The system of claim 1 wherein:
the controller is further configured to detect the state of the first cell via a first Kalman filter computing structure and to detect the difference of the state of the second cell with the state of the first cell via a second Kalman filter computing structure that is simpler than the first Kalman filter computing structure.

6. The system of claim 1 wherein:
the controller is further configured to detect the state of the first cell periodically at a first rate and is configured to detect the difference of the state of the second cell with the state of the first cell periodically at a second rate that is equal to or slower than the first rate.

7. The system of claim 1 wherein:
the controller is further configured to select one of the cells of the battery as being the first cell based on predetermined criteria whereby the first cell is representative of the cells of the battery according to the predetermined criteria.

8. The system of claim 1 wherein:
the state of each cell of the battery is a state-of-charge (SOC); and
the controller is further configured to charge and discharge the battery according to a SOC of the battery derived at least in part from (i) the SOC of the first cell and (ii) the difference of the SOC of the second cell with the SOC of the first cell.

9. The system of claim 1 wherein:
the state of each cell of the battery is a charge capacity and a power capability; and
the controller is further configured to charge and discharge the battery according to a charge capacity of the battery derived at least in part from (i) the charge capacity of the first cell and (ii) the difference of the charge capacity of the second cell with the charge capacity of the first cell and/or according to a power capability of the battery derived at least in part from (i) the power capability of the first cell and (ii) the difference of the power capability of the second cell with the power capability of the first cell.

10. The system of claim 1 wherein:
the battery is a traction battery of an electrified vehicle.

11. A method comprising:
detecting a state of a first cell of a battery based on electrical measurements of the first cell;
detecting a difference of a state of a second cell of the battery with the state of the first cell based on electrical measurements of the second cell and on the state of the first cell;
detecting the state of the second cell from a summation of (i) the state of the first cell and (ii) the difference of the state of the second cell with the state of the first cell; and
charging and discharging the battery according to a state of the battery derived from a summation of the state of the first cell and the state of the second cell.

12. The method of claim 11 further comprising:
detecting a difference of a state of a third cell of the battery with the state of the first cell based on electrical measurements of the third cell and on the state of the first cell;
detecting the state of the third cell from a summation of (i) the state of the first cell and (ii) the difference of the state of the third cell with the state of the first cell; and
charging and discharge the battery according to the state of the battery derived from a summation of the state of the first cell, the state of the second cell, and the state of the third cell.

13. The method of claim 11 further comprising:
detecting a state of a third cell of the battery based on electrical measurements of the third cell;
detecting a difference of a state of a fourth cell of the battery with the state of the third cell based on electrical measurements of the fourth cell and on the state of the third cell;
detecting the state of the fourth cell from a summation of (i) the state of the third cell and (ii) the difference of the state of the fourth cell with the state of the third cell; and
charging and discharging the battery according to the state of the battery derived from a summation of factor A and factor B, wherein factor A is a summation of the state of the first cell and the state of the second cell, and factor B is a summation of the state of the third cell and the state of the fourth cell.

14. The method of claim 11 wherein:
detecting the state of the first cell based on electrical measurements of the first cell is performed with a first Kalman filter computing structure; and
detecting the difference of the state of the second cell with the state of the first cell based on electrical measurements of the second cell and on the state of the first cell is performed with a second Kalman filter computing structure that is simpler than the first Kalman filter computing structure.

15. The method of claim 11 wherein:
detecting the state of the first cell is done periodically at a first rate; and
detecting the difference of the state of the second cell with the state of the first cell is done periodically at a second rate that is equal to or slower than the first rate.

16. The method of claim 11 further comprising:
selecting one of a plurality of cells of the battery as being the first cell based on predetermined criteria whereby the first cell is representative of the cells of the battery according to the predetermined criteria.

17. An electrified vehicle comprising:
a traction battery having a plurality of modules, each module including a plurality of cells; and
a controller configured to select a cell of each module as being a representative cell that is representative of the cells of the module according to predetermined criteria with the other cells of the module being considered as being difference cells;
the controller is further configured to detect a state of the representative cell of each module based on electrical measurements of the representative cell;
the controller is further configured to detect a difference of a state of each difference cell of each module with the state of the representative cell of the module based on electrical measurements of the difference cell and on the state of the representative cell;
the controller is further configured to detect the state of each difference cell of each module from a summation of (i) the state of the representative cell of the module and (ii) the difference of the state of the difference cell with the state of the representative cell; and
the controller is further configured to charge and discharge the battery according to a state of the battery derived from a summation for each module of the state of the representative cell of the module and the states of the difference cells of the module.

18. The electrified vehicle of claim 17 wherein:
the controller is further configured to detect the state of the representative cell of each module via a first Kalman filter computing structure and to detect the difference of the state of each difference cell of each module with the state of the representative cell of the module via a second Kalman filter computing structure that is simpler than the first Kalman filter computing structure.

19. The electrified vehicle of claim 18 wherein:
the controller is further configured to detect the state of the representative cell of each module periodically at a first rate and is configured to detect the difference of the state of each difference cell of each module with the state of the representative cell of the module periodically at a second rate that is equal to or slower than the first rate.

20. The electrified vehicle of claim 17 wherein:
the state of each cell is a state-of-charge (SOC) of the cell.
